(19) United States
(12) Patent Application Publication
(10) Pub. No.: US 2017/0363656 A1
(43) Pub. Date: Dec. 21, 2017

(54) Z-AXIS STRUCTURE IN ACCELEROMETER

(71) Applicant: Goertek.Inc, Shandong (CN)

(72) Inventors: Huabin Fang, Shandong (CN); Qinglin Song, Shandong (CN); Yanmei Sun, Shandong (CN)

(21) Appl. No.: 15/542,761

(22) PCT Filed: Jul. 23, 2015
(86) PCT No.: PCT/CN2015/084969

§ 371 Date: Jul. 11, 2017

(30) Foreign Application Priority Data
Jan. 30, 2015 (CN) 201510051755.9

(51) Int. Cl. G01P 15/125

(52) U.S. Cl. CPC G01P 15/125

(57) ABSTRACT

A Z-axis structure in an accelerometer comprises a mass block (1) moving relative to a substrate (4) in a Z-axis direction in a reciprocating manner. A first movable electrode plate (10) and a second movable electrode plate (11) are disposed on a sidewall of the mass block (1). A first fixed electrode plate (20) and a second fixed electrode plate (30) extending toward a plane consisting of an X axis and a Y axis are also disposed on the sidewall of the mass block (1). According to the Z-axis accelerometer, a lower plate structure is discarded, therefore the limitation of a lower plate to the Z-axis accelerometer is avoided, the mass block (1) can move up and down in the Z-axis direction, rather than moving in a teeterboard moving manner, the parasitic capacitance of the Z-axis accelerometer is reduced, and the detection precision is improved; the contact between the movable mass block (1) and the substrate (4) is avoided, and therefore the chip reliability is improved; the mass block (1) and the fixed electrodes are located at a same layer, therefore the consistence is superior to that of the traditional Z-axis structure; in addition, anchor points can be centralized in design, so as to reduce the sensitivity of a chip to the changes of the temperature and stress.

### CROSS REFERENCE TO RELATED APPLICATIONS

This application is a national stage application, filed under 35 U.S.C. §371, of International Application No. PCT/CN2015/084969, filed Jul. 23, 2015, which claims priority to Chinese Application No. 201510051755.9, filed Jan. 30, 2015, the contents of both of which as are hereby incorporated by reference in their entirety.

### BACKGROUND

The present invention relates to the field of micro-electromechanical systems (MEMS), and more particularly, relates to a micro-electromechanical inertial measurement module, in particular to a Z-axis structure in an accelerometer.

Conventional Z-axis accelerometers are parallel-plate capacitive accelerometers, and the movement mode of mass blocks is similar to that of a seesaw structure. Referring to FIG. 1, a first plate electrode 2 and a second plate electrode 3 made of metal or polycrystalline silicon are arranged on a substrate 4 below a mass block 1, and the mass block 1 and the two electrodes form two capacitors (C1 and C2), respectively. In the case of no acceleration input, the distance from the mass block 1 to the first plate electrode 2 is equal to that from the mass block to the second plate electrode 3, so that values of the Cl and C2 are the same here.

In the case that acceleration is input, the mass block 1 is no longer balanced and will flip over like a seesaw. One end of the mass block 1 is downward, while the other end thereof is upward. Here, the distance from the mass block 1 to the first plate electrode 2 is unequal to that from the mass block to the second plate electrode 3. Referring to the view direction of FIG. 2, the value of the Cl is reduced, while the value of the C2 is increased. A difference value between the Cl and the C2 is proportional to the input acceleration, and an output positive/negative sign reflects the direction of the input acceleration.

However, the above-mentioned Z-axis accelerometer adopting the above structure has several defects as follows.

(a) The process is complex and the cost is high. At present, X-Y axis accelerometers adopt solutions using plane comb-shaped capacitors. Thus, for the X-Y axis accelerometer, there is no need to introduce a plate electrode on a substrate. But the solution of the above Z-axis accelerometer is completely different as a plate electrode on a substrate is absolutely essential. That is, in order to achieve the design of the Z-axis accelerometer, it is required to add a layer of plate electrode, so that the process complexity and the cost are increased.

(b) The accuracy is low. The plate electrode is located on the substrate, so that parasitic capacitance of the Z-axis accelerometer is larger, affecting the accuracy of the Z-axis accelerometer. As for the XY-axis accelerometer, a capacitor electrode plate is suspended, so that parasitic capacitance of the X-Y axis accelerometer is generally reduced by half or above relative to that of the Z-axis accelerometer. Therefore, in general, the accuracy of the X-Y axis accelerometer is higher than that of the Z-axis accelerometer.

(c) The reliability is poor. The reliability of the Z-axis accelerometer is always a difficult problem. As a lower electrode plate is a necessary part of the Z-axis accelerometer, the distance between the mass block and the lower electrode plate must be controlled to a relatively small range. As a result, the mass block is likely to be in contact with the substrate or the lower electrode plate, even to adhere to the substrate to be inseparable, resulting in complete failure of a chip.

(d) The chip area is larger. The Z-axis accelerometer is of a plate capacitor structure, so that it occupies a relatively large area. Generally, in a three-axis accelerometer, the Z-axis accelerometer occupies 40% or more of the whole area.

### BRIEF SUMMARY

For solving the problems in the prior art, the present invention provides a Z-axis structure in an accelerometer.

In order to achieve the above object, the technical solution of the present invention is to provide a Z-axis structure in an accelerometer. The Z-axis structure comprises: a substrate; a mass block supported above the substrate via elastic beams connected with side walls of the mass block and capable of translating back and forth in a Z-axis direction relative to the substrate, wherein first movable electrode pole pieces and second movable electrode pole pieces are arranged on the side walls of the mass block; and first fixed electrode pole pieces and second fixed electrode pole pieces which are arranged on the substrate, the first and second fixed electrode pole pieces extending in directions of a plane composed of an X-axis and a Y-axis, respectively, wherein side walls of the first movable electrode pole pieces face those of the first fixed electrode pole pieces to form a first Z-axis detection capacitor; side walls of the second movable electrode pole pieces face those of the second fixed electrode pole pieces to form a second Z-axis detection capacitor; and in an initial state, an end face of one end of the first fixed electrode pole piece is lower than that of the same end of the corresponding first movable electrode pole piece, while an end face of one end, the same as that of the first fixed electrode pole piece, of the second fixed electrode pole piece is higher than that of the end, the same as that of the first fixed electrode pole piece, of the corresponding second movable electrode pole piece.

In certain embodiments, the mass block is provided with through holes, and the first and second movable electrode pole pieces are arranged on side walls of the through holes in the mass block.

In certain embodiments, in the initial state, the upper end face of the first fixed electrode pole piece is lower than that of the corresponding first movable electrode pole piece; and the upper end face of the second fixed electrode pole piece is higher than that of the corresponding second movable electrode pole piece.

In certain embodiments, in the initial state, the lower end face of the first fixed electrode pole piece is flush with that of the corresponding first movable electrode pole piece; and the lower end face of the second fixed electrode pole piece is flush with that of the corresponding second movable electrode pole piece.

In certain embodiments, in the initial state, the lower end faces of the first and second fixed electrode pole pieces and the first and second movable electrode pole pieces are flush.

In certain embodiments, in the initial state, the lower end face of the first fixed electrode pole piece is lower than that of the corresponding first movable electrode pole piece; and the lower end face of the second fixed electrode pole piece is higher than that of the corresponding second movable electrode pole piece.

In certain embodiments, a plurality of first fixed electrode pole pieces and first movable electrode pole pieces are arranged respectively; the plurality of first movable electrode pole pieces are distributed along the side wall of the mass block; and the plurality of first fixed electrode pole pieces and the multiple first movable electrode pole pieces form a comb-shaped capacitor structure.

In certain embodiments, a plurality of second fixed electrode pole pieces and second movable electrode pole pieces are arranged respectively; the plurality of second movable electrode pole pieces are distributed along the other side wall of the mass block; and the plurality of second fixed electrode pole pieces and the multiple second movable electrode pole pieces form a comb-shaped capacitor structure.

In certain embodiments, the first fixed electrode pole pieces and the second fixed electrode pole pieces are arranged in parallel on the substrate.

In certain embodiments, the first and second movable electrode pole pieces are integrally formed with the mass block.

In the Z-axis structure of the accelerometer provided by the present invention, a lower electrode plate structure is omitted, so that limitation of the lower electrode plate to the Z-axis accelerometer is prevented, and the movement mode of the mass block is no longer a seesaw-type one, but is replaced with vertical translation in the Z-axis direction, reducing the parasitic capacitance of the Z-axis accelerometer and improving the detection accuracy. In addition, a chip area occupied by the Z-axis accelerometer is reduced as the lower electrode plate structure is omitted, reducing the complexity of a manufacturing process and the cost, and improving the reliability of a chip. Moreover, in this Z-axis structure, the mass block is prevented from being in contact with the substrate, so that the reliability of the chip is improved. Further, as the mass block and the fixed electrode are located on the same layer, compared with a conventional Z-axis structure, the better consistency is achieved, and anchor points can be designed to be more concentrated to reduce the sensitivity of the chip to changes of temperature and stress.

### BRIEF DESCRIPTION OF THE FIGURES

FIG. 1 shows a schematically structural view of a Z-axis structure in the prior art.

FIG. 2 shows a schematic view of a mass block shown in FIG. 1 during deflection.

FIG. 3 shows a schematic view of a Z-axis structure of the present invention.

FIG. 4A shows a schematic view of a movement mode of a mass block of the present invention in an initial state.

FIG. 4B shows a schematic view of a movement mode of the mass block of the present invention when it is subjected to acceleration in the negative Z-axis direction.

FIG. 4C shows a schematic view of a movement mode of the mass block of the present invention when it is subjected to acceleration in the positive Z-axis direction.

FIGS. 5A-5C respectively show a schematic diagram of a Z-axis detection capacitor of the present invention.

FIGS. 6A-6C respectively show a schematic diagram of the Z-axis detection capacitor according to another embodiment structure of the present invention.

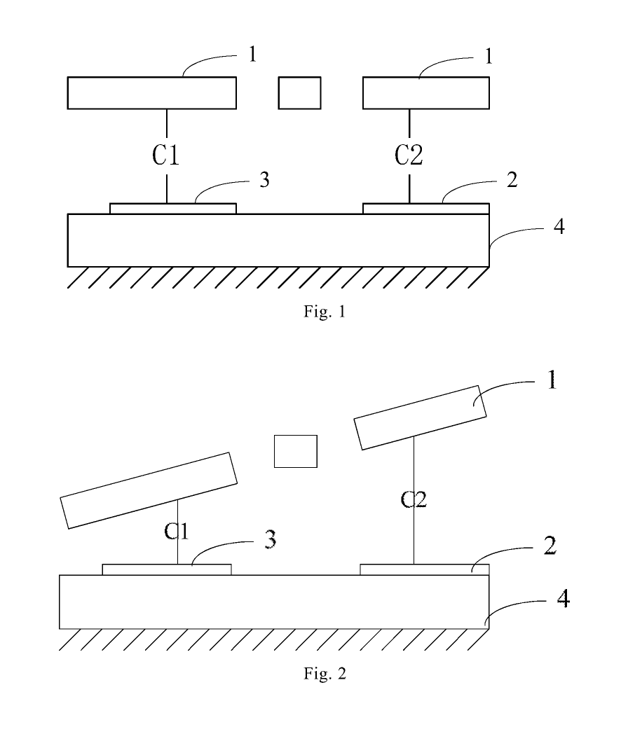

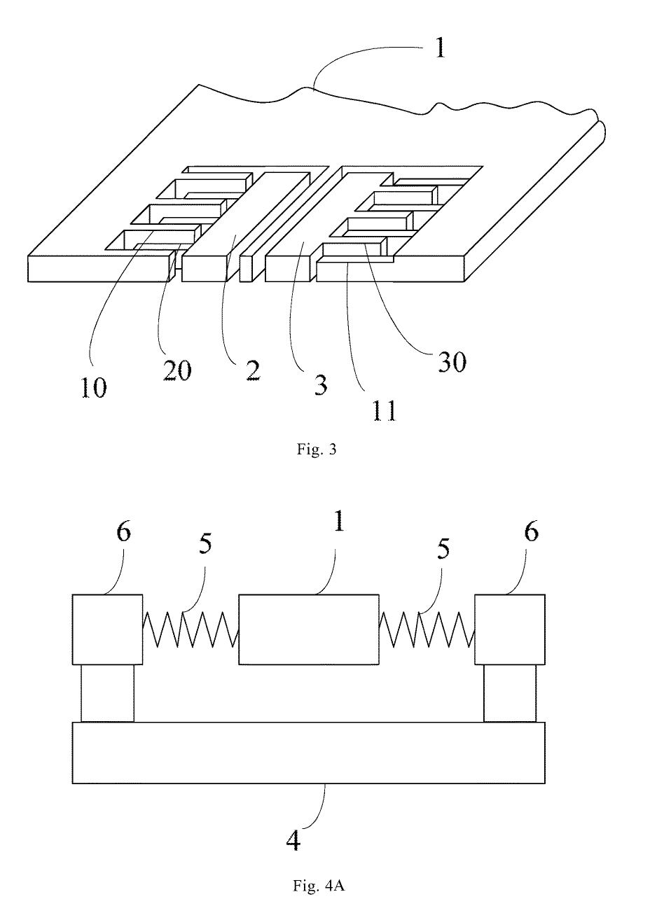

### DETAILED DESCRIPTION OF VARIOUS EMBODIMENTS

In order to make the solved technical problems, the technical solutions and the technical effects of the present invention easier to understand, the specific embodiments of the present invention will be further described with reference to the accompanying drawings hereinafter.

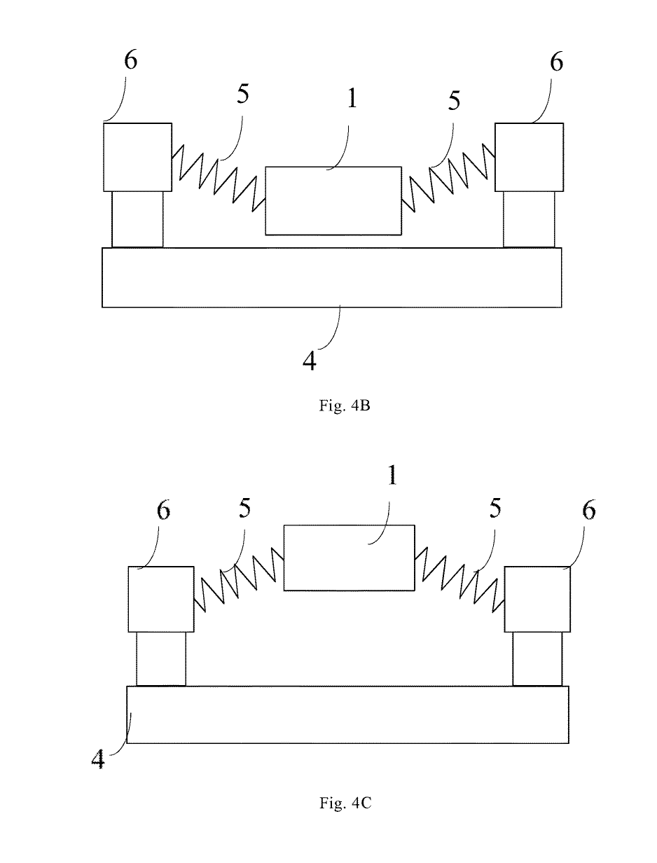

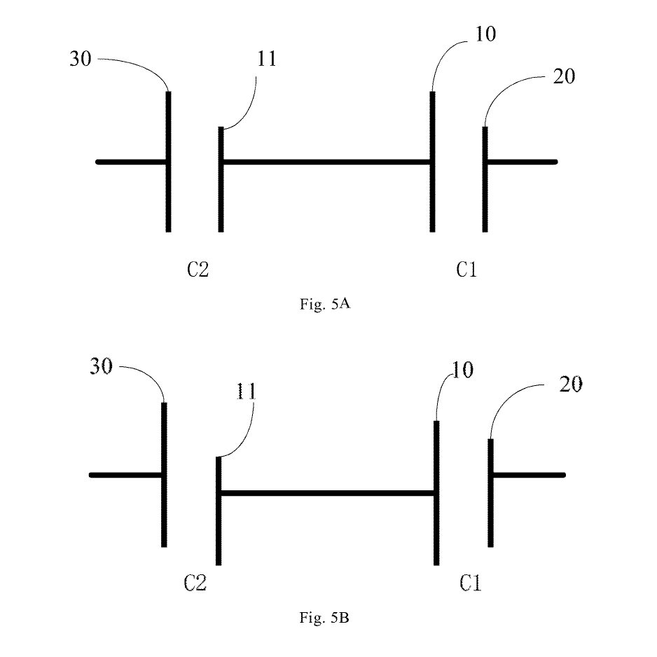

In an accelerometer adopting a conventional structure, its X-axis and Y-axis directions utilize a translation mode, while its Z-axis direction utilizes a seesaw-type deflection mode. Compared with the conventional Z-axis accelerometer structure, the present invention provides a Z-axis structure in an accelerometer, and the Z-axis structure can be configured to detect a Z-axis acceleration signal in the vertical direction. Referring to FIGS. 3 and 4A, the Z-axis structure comprises a substrate 4 on which various functional components and the like of the accelerometer can be arranged. A mass block 1 may be connected onto anchor points 6 on the substrate 4 via elastic beams 5. Particularly, the side walls of the mass block 1 are connected onto the anchor points 6 on the substrate 4 via the elastic beams 5. Relating to a particular process, in order to ensure that there is an enough gap between the mass block 1 and the substrate 4, the anchor points 6 can also be raised via isolation parts. When being subjected to corresponding force, the mass block 1 is moved up and down relative to the substrate 4. More precisely speaking, when being subjected to acceleration in the Z-axis direction, the mass block 1 is moved upwards or downwards in the Z-axis direction.

Referring to the view direction of FIG. 4A, it is defined that the positive Z-axis direction is upward, and the negative Z-axis direction is downward. Referring to FIG. 4B, when being subjected to force in the negative Z-axis direction, the mass block 1 is moved downwards under the action of the elastic beams to stretch the elastic beams downwards. Referring to FIG. 4C, when being subjected to force in the positive Z-axis direction, the mass block 1 is moved upwards under the action of the elastic beams to stretch the elastic beams upwards. In order to prevent the deflection of the mass block 1, a plurality of elastic beams is arranged to provide stable support, and the detailed description is omitted herein.

First movable electrode pole pieces 10 and second movable electrode pole pieces 11 are arranged on the side walls of the mass block 1. The first movable electrode pole pieces 10, the second movable electrode pole pieces 11 and the mass block 1 are integrally formed to be used as a common pole piece for differential detection capacitors. When the mass block 1 is displaced in the Z-axis direction through external force, the first movable electrode pole pieces 10 and the second movable electrode pole pieces 11 are moved in synchronism with the mass block 1. The first movable electrode pole pieces 10 and the second movable electrode pole pieces 11 may be arranged at the edge of the mass block 1. In certain embodiments, the mass block 1 is provided with through holes, and the first movable electrode pole pieces 10 and the second movable electrode pole pieces 11 are arranged on the side walls of the through holes of the mass block 1.

A first fixed electrode 2 and a second fixed electrode 3 are further arranged on the substrate 4 to constitute detection capacitors with the first movable electrode pole pieces 10 and the second movable electrode pole pieces 11, respectively. First fixed electrode pole pieces 20 and second fixed electrode pole pieces 30 which extend outwardly are arranged at the edges of the first fixed electrode 2 and the second fixed electrode 3, respectively. The first fixed electrode 2 and the first fixed electrode pole pieces 20 are integrally formed, and the second fixed electrode 3 and the second fixed electrode pole pieces 30 are integrally formed. The first fixed electrode pole pieces 20 and the second fixed electrode pole pieces 30 are located in the directions of a plane composed by the X-axis and the Y-axis. That is, the extending directions of the first fixed electrode pole pieces 20 and the second fixed electrode pole pieces 30 are perpendicular to the movement direction of the mass block 1.

For example, in a specific embodiment of the present invention, the first fixed electrode pole pieces 20 may extend in the X-axis direction, and the second fixed electrode pole pieces 30 may extend in the X-axis direction, too. Here, the first fixed electrode 2 and the second fixed electrode 3 may be arranged in parallel on the substrate 4. Of course, the second fixed electrode pole pieces 30 may also extend in the Y-axis direction as long as the extending direction is substantially perpendicular to the movement direction of the mass block 1.

Side walls of the first movable electrode pole pieces 10 face those of the first fixed electrode pole pieces 20 to form a first Z-axis detection capacitor. That is, the side walls located in an X-Z or Y-Z plane of the two kinds of pole pieces face each other, so that when the first movable electrode pole pieces 10 are displaced in the Z-axis direction along with the mass block 1, face-to-face areas and locations between the side walls of the two kinds of pole pieces are changed, changing the first Z-axis detection capacitor.

Similarly, side walls of the second movable electrode pole pieces 11 face those of the second fixed electrode pole pieces 30 to form a second Z-axis detection capacitor. That is, the side walls located in the X-Z or Y-Z plane of the two kinds of pole pieces face each other, so that when the second movable electrode pole pieces 11 are displaced in the Z-axis direction along with the mass block 1, face-to-face areas and locations between the side walls of the two kinds of pole pieces are changed, changing the second Z-axis detection capacitor.

In order to ensure that the first Z-axis detection capacitor and the second Z-axis detection capacitor may form a differential capacitor structure, in an initial state, an end face of one end of the first fixed electrode pole piece 20 is lower than that of the same end of the corresponding first movable electrode pole piece 10, while an end face of one end, the same as that of the first fixed electrode pole piece 20, of the corresponding second fixed electrode pole piece 30 is higher than that of the end, the same as that of the first fixed electrode pole piece 20, of the corresponding second movable electrode pole piece 11.

For example, in a specific embodiment of the present invention, the upper end face of the first fixed electrode pole piece 20 is lower than that of the corresponding first movable electrode pole piece 10; and the upper end face of the second fixed electrode pole piece 30 is higher than that of the corresponding second movable electrode pole piece 11. For instance, the thickness of the first movable electrode pole pieces 10 may be reduced by etching.

Here, the lower end faces of the all pole pieces may be flush or uneven. The two circumstances will be introduced hereinafter respectively.

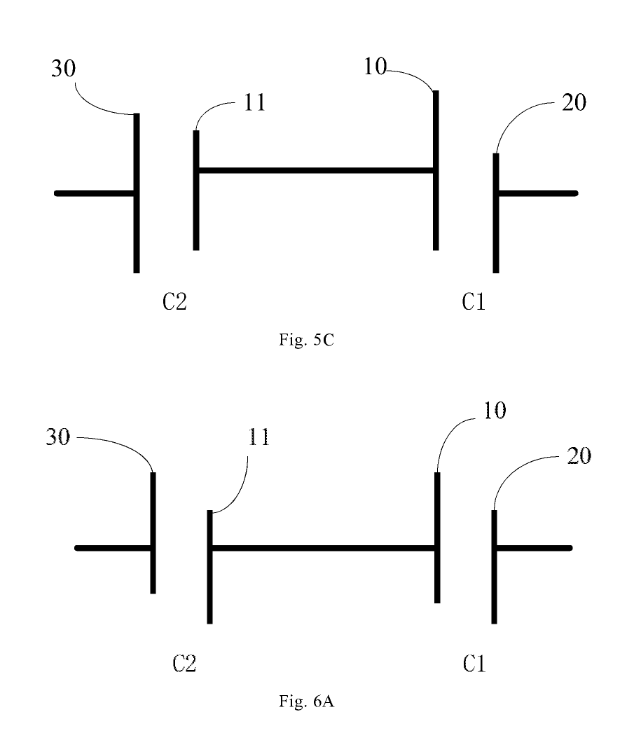

In a specific exemplary embodiment of the present invention, the lower end face of the first fixed electrode pole piece 20 is flush with that of the corresponding first movable electrode pole piece 10; and the lower end face of the second fixed electrode pole piece 30 is flush with that of the corresponding second movable electrode pole piece 11. That is, in this embodiment, referring to FIG. 5A, the upper end face of the first fixed electrode pole piece 20 is lower than that of the corresponding first movable electrode pole piece 10, and the lower end faces of the two pole pieces are flush; and the upper end face of the second fixed electrode pole pieces 30 is higher than that of the corresponding second movable electrode pole piece 11, and the lower end faces of the two pole pieces are flush. In a particularly advantageous technical solution of the present invention, in order to facilitate manufacture, the lower end faces of the first fixed electrode pole pieces 20, the first movable electrode pole pieces 10, the second fixed electrode pole pieces 30 and the second movable electrode pole pieces 11 are flush.

Referring to FIGS. 4B and 5B, when being subjected to acceleration in the negative Z-axis direction, the mass block 1 stretches the elastic beams and is displaced downwards. Here, the first movable electrode pole pieces 10 and the second movable electrode pole pieces 11 are displaced downwards along with the mass block 1. As the direct facing area between the second movable electrode pole piece 11 and the corresponding second fixed electrode pole piece 30 is reduced, a value of a second Z-axis detection capacitor C2 is reduced; and the first movable electrode pole pieces 10 are displaced downwards, so that more electric field lines between the lower end of the first fixed electrode pole piece 20 and the first movable electrode pole piece 10 are intersected, increasing the edge capacitance therebetween, and finally, increasing a value of a first Z-axis detection capacitor Cl composed of the first movable electrode pole pieces 10 and the first fixed electrode pole pieces 20 as a whole. Therefore, the first Z-axis detection capacitor Cl and the second Z-axis detection capacitor C2 form a differential capacitor structure configured to detect an acceleration signal in the negative Z-axis direction.

Referring to FIGS. 4C and 5C, when being subjected to acceleration in the positive Z-axis direction, the mass block 1 stretches the elastic beams and is displaced upwards. Here, the first movable electrode pole pieces 10 and the second movable electrode pole pieces 11 are displaced upwards along with the mass block 1. As the direct facing area between the first movable electrode pole piece 10 and the corresponding first fixed electrode pole piece 20 is reduced, a value of the first Z-axis detection capacitor Cl is reduced; and the second movable electrode pole pieces 11 are displaced upwards, so that more electric field lines between the lower end of the second movable electrode pole piece 11 and the corresponding second fixed electrode pole piece 30 are intersected, increasing the edge capacitance therebetween, and finally, increasing a value of the second Z-axis detection capacitor C2 composed of the second movable electrode pole pieces 11 and the second fixed electrode pole pieces 30 as a whole. Therefore, the first Z-axis detection capacitor C1 and the second Z-axis detection capacitor C2 form a differential capacitor structure configured to detect an acceleration signal in the positive Z-axis direction.

In the Z-axis structure provided by the present invention, a lower electrode plate structure is omitted, so that limitation of the lower electrode plate to the Z-axis accelerometer is prevented, and the movement mode of the mass block is no longer a seesaw-type one, but is replaced with vertical translation in the Z-axis direction, reducing the parasitic capacitance of the Z-axis accelerometer and improving the detection accuracy. In addition, a chip area occupied by the Z-axis structure is reduced as the lower electrode plate structure is omitted, reducing the complexity of the manufacturing process and the cost. Moreover, in this Z-axis structure, the mass block is prevented from being in contact with the substrate, so that the reliability of the chip is improved. Further, the mass block and the fixed electrode are located on the same layer, first, compared with a conventional Z-axis structure, the better consistency is achieved, and anchor points can be designed to be more concentrated to reduce the sensitivity of the chip to changes of temperature and stress.

In another embodiment of the present invention, the lower end faces of all the first fixed electrode pole pieces 20, the first movable electrode pole pieces 10, the second fixed electrode pole pieces 30 and the second movable electrode pole pieces 11 are flush.

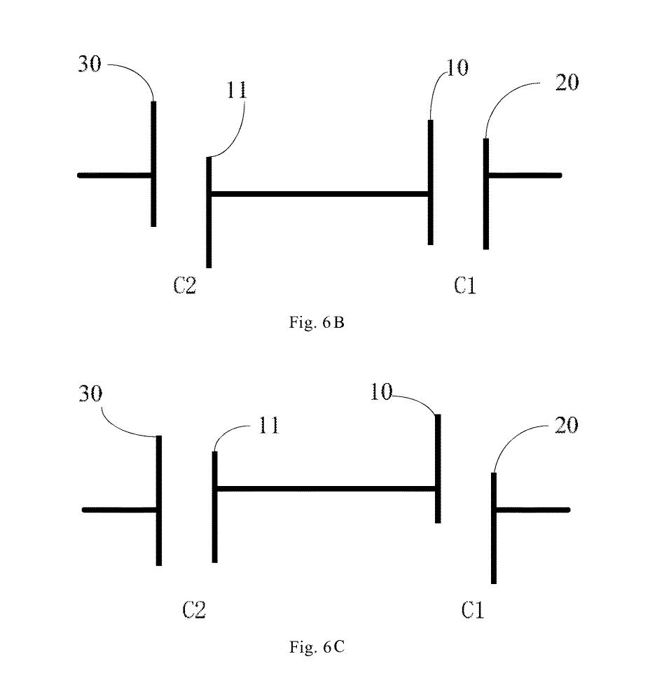

For example, the lower end face of the first fixed electrode pole piece 20 is lower than that of the corresponding first movable electrode pole piece 10; and the lower end face of the second fixed electrode pole piece 30 is higher than that of the corresponding second movable electrode pole piece 11. Referring to FIG. 6A, in an initial state, the upper end face of the first fixed electrode pole piece 20 is lower than that of the corresponding first movable electrode pole piece 10, and the lower end face of the first fixed electrode pole piece 20 is lower than that of the corresponding first movable electrode pole piece 10; and the upper end face of the second fixed electrode pole piece 30 is higher than that of the corresponding second movable electrode pole piece 11, and the lower end face of the second fixed electrode pole piece 30 is higher than that of the corresponding second movable electrode pole piece 11.

Referring to FIGS. 4B and 6B, when being subjected to acceleration in the negative Z-axis direction, the mass block 1 stretches the elastic beams and is displaced downwards. Here, the first movable electrode pole pieces 10 and the second movable electrode pole pieces 11 are displaced downwards along with the mass block 1. The direct facing area between the first movable electrode pole piece 10 and the corresponding first fixed electrode pole piece 20 is increased, so that the value of the first Z-axis detection capacitor Cl is increased; while the direct facing area between the second movable electrode pole piece 11 and the corresponding second fixed electrode pole piece 30 is reduced, so that the value of the second Z-axis detection capacitor C2 is reduced. Finally, the first Z-axis detection capacitor C1 and the second Z-axis detection capacitor C2 form a differential capacitance structure configured to detect the acceleration signal in the negative Z-axis direction.

Referring to FIGS. 4C and 6C, when being subjected to acceleration in the positive Z-axis direction, the mass block 1 stretches the elastic beams and is displaced upwards. Here, the first movable electrode pole pieces 10 and the second movable electrode pole pieces 11 are displaced upwards along with the mass block 1. The direct facing area between the first movable electrode pole piece 10 and the corresponding first fixed electrode pole piece 20 is reduced, so that the value of the first Z-axis detection capacitor Cl is reduced; while the direct facing area between the second movable electrode pole piece 11 and the corresponding second fixed electrode pole piece 30 is increased, so that the value of the second Z-axis detection capacitor C2 is increased. Finally, the first Z-axis detection capacitor Cl and the second Z-axis detection capacitor C2 form the differential capacitance structure configured to detect the acceleration signal in the positive Z-axis direction.

In the present invention, there may be multiple first fixed electrode pole pieces 20 and first movable electrode pole pieces 10 which are distributed along the side walls of the first fixed electrode 2 and the mass block 1, respectively. The multiple first fixed electrode pole pieces 20 and first movable electrode pole pieces 10 constitute a comb-shaped capacitor structure, thereby improving the detection accuracy. Similarly, there may be multiple second fixed electrode pole pieces 30 and second movable electrode pole pieces 11 which are distributed along the side walls of the second fixed electrode 3 and the mass block 1, respectively. The multiple second fixed electrode pole pieces 30 and second movable electrode pole pieces 11 constitute the other comb-shaped capacitor structure, thereby improving the detection accuracy.

The present invention is described in detail with reference to various exemplary and/or advantageous embodiments. However, it is obvious to those skilled in the art that changes and additions to the various embodiments will be apparent through the study of the foregoing description. For example, the above terms “upper end face” and the “lower end face” are relative concepts and are distinguished from each other only for facilitating the description. In the description of the present invention, these should not be used to limit the protective scope of the present application. The intention of the applicant is that all such changes and additions shall fall within the protective scope of the present invention defined by the claims.

1-10. (canceled)

11. A Z-axis structure in an accelerometer, the Z-axis structure comprising:
a substrate (4);
a mass block (1) which is supported above the substrate (4) via elastic beams (5) connected with side walls of the mass block and is capable of translating back and forth in a Z-axis direction relative to the substrate (4), wherein first movable electrode pole pieces (10) and second movable electrode pole pieces (11) are arranged on the side walls of the mass block (1); and
first fixed electrode pole pieces (20) and second fixed electrode pole pieces (30) which are arranged on the substrate (4), the first fixed electrode pole pieces (20) and the second fixed electrode pole pieces (30) extending in directions of a plane composed of an X-axis and a Y-axis, respectively,
wherein:
side walls of the first movable electrode pole pieces (10) face those of the first fixed electrode pole pieces (20) to form a first Z-axis detection capacitor; side walls of the second movable electrode pole pieces (11) face those of the second fixed electrode pole pieces (30) to form a second Z-axis detection capacitor; and
in an initial state, an end face of one end of the first fixed electrode pole piece (20) is lower than that of the same end of the corresponding first movable electrode pole piece (10), while an end face of one end, the same as that of the first fixed electrode pole piece (20), of the second fixed electrode pole piece (30) is higher than that of the end, the same as that of the first fixed electrode pole piece (20), of the corresponding second movable electrode pole piece (11).

12. The Z-axis structure of claim 11, wherein the mass block (1) is provided with through holes, and the first movable electrode pole pieces (10) and the second movable electrode pole pieces (11) are arranged on side walls of the through holes of the mass block (1).

13. The Z-axis structure of claim 11, wherein:
in the initial state, the upper end face of the first fixed electrode pole piece (20) is lower than that of the corresponding first movable electrode pole piece (10); and
the upper end face of the second fixed electrode pole piece (30) is higher than that of the corresponding second movable electrode pole piece (11).

14. The Z-axis structure of claim 13, wherein:
in the initial state, the lower end face of the first fixed electrode pole piece (20) is flush with that of the corresponding first movable electrode pole piece (10); and
the lower end face of the fixed electrode pole piece (30) is flush with that of the corresponding second movable electrode pole piece (11).

15. The Z-axis structure of claim 14, wherein, in the initial state, the lower end faces of all the first fixed electrode pole pieces (20), the first movable electrode pole pieces (10), the second fixed electrode pole pieces (30) and the second movable electrode pole pieces (11) are flush.

16. The Z-axis structure of claim 13, wherein:
in the initial state, the lower end face of the first fixed electrode pole piece (20) is lower than that of the corresponding first movable electrode pole piece (10); and
the lower end face of the second fixed electrode pole piece (30) is higher than that of the corresponding second movable electrode pole piece (11).

17. The Z-axis structure of claim 11, wherein:
a plurality of first fixed electrode pole pieces (20) and first movable electrode pole pieces (10) are arranged respectively, the plurality of movable electrode pole pieces (10) being distributed along the side wall of the mass block (1); and
the plurality of first fixed electrode pole pieces (20) and first movable electrode pole pieces (10) form a comb-shaped capacitor structure.

18. The Z-axis structure of claim 17, wherein:
a plurality of second fixed electrode pole pieces (30) and second movable electrode pole pieces (11) are arranged respectively, the plurality of second movable electrode pole pieces (11) being distributed along the other side wall of the mass block (1); and
the plurality of second fixed electrode pole pieces (30) and second movable electrode pole pieces (11) form the other comb-shaped capacitor structure.

19. The Z-axis structure of claim 18, wherein the first fixed electrode pole pieces (20) and the second fixed electrode pole pieces (30) are arranged in parallel on the substrate (4).

20. The Z-axis structure of claim 11, wherein the first movable electrode pole pieces (10) and the second movable electrode pole pieces (11) are integrally formed with the mass block (1).
